(19) United States
(12) Patent Application Publication
(10) Pub. No.: US 2025/0314457 A1
(43) Pub. Date: Oct. 9, 2025

(54) Geodetic Deconfliction Technique

(71) Applicants: James L. Latourell, JR., Fredericksburg, VA (US); Devin Allen Coates, Berlin Heightrs, OH (US)

(72) Inventors: James L. Latourell, JR., Fredericksburg, VA (US); Devin Allen Coates, Berlin Heightrs, OH (US)

(73) Assignee: United States of America, as represented by the Secretary of the Navy, Arlington, VA (US)

(21) Appl. No.: 18/735,526

(22) Filed: Jun. 6, 2024

Related U.S. Application Data
(63) Continuation-in-part of application No. 18/626,808, filed on Apr. 4, 2024.

(51) Int. Cl. F41G 3/04; G05D 25/02

(52) U.S. Cl. CPC F41G 3/04; G05D 25/02

(57) ABSTRACT

A software method is provided for inhibiting an electromagnetic beam emitted by a laser in a pointing direction from passing by defining a plane in relation to earth's center. The method includes calculating a first radial vector; determining an intersection point; ascertaining whether the intersection point lies within an excluded plane; and displaying one of inhibition and absence. The first radial vector is determined from earth's center to a beam origin of the laser in azimuth and elevation. The intersection point is calculated along a second radial vector from the beam origin. The intersection point is ascertained whether that lies within an excluded plane, with response of inhibition when valid. The inhibition is then displayed.

### CROSS REFERENCE TO RELATED APPLICATION

The invention is a Continuation-in-Part, claims priority to and incorporates by reference in its entirety U.S. patent application Ser. No. 18/626,808 filed Apr. 4, 2024 and assigned Navy Case 107598.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to laser control. In particular, the invention relates to avoidance of no-fire zones in directing and activating a laser.

Previous laser systems relied on a combination of software and hardware to electrically inhibit a laser's firing signal. The software was required to interface directly with many of the laser system's hardware components. The software performed coordinate transformations and safety calculations to arrive at a periodic safe or not safe to fire decision. The safe or not safe to fire decision was sent to a hardware item that passed or interrupted the laser's firing signal.

### SUMMARY

Conventional laser control techniques yield disadvantages addressed by various exemplary embodiments of the present invention. In particular, various exemplary embodiments provide a software method for inhibiting an electromagnetic beam emitted by a laser in a pointing direction from passing into a no-fire zone by defining a plane in relation to earth's center.

The method includes calculating a first radial vector; determining an intersection point; ascertaining whether the intersection point lies within an excluded plane; and displaying one of inhibition and absence. The first radial vector is determined from earth's center to a beam origin of the laser in azimuth and elevation. The intersection point is calculated along a second radial vector from the beam origin. The intersection point is ascertained whether that lies within an excluded plane, with response of inhibition when valid. The inhibition is then displayed.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of a targeting environment;

FIG. 2 is a geometric view of directional orientations;

FIG. 3 is a geometric view of planar shapes for defining regions;

FIG. 4 is a block diagram view of boundary definitions;

FIGS. 5A and 5B are geometric views of points and vectors;

FIG. 6 is a code text view of logical instructions;

FIG. 7 is a code text view of an intersection message;

FIG. 8 is a representational view of vertical boundary interception; and

FIG. 9 is a representational view horizontal boundary interception.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

The disclosure generally employs quantity units with the following abbreviations: length in meters (m), feet (′) or nautical miles (nm), mass in grams (g), time in seconds (s), angles in degrees (°), force in newtons (N), temperature in kelvins (K), energy in joules (J) and frequencies in hertz (Hz). Supplemental measures can be derived from these, such as density in grams-per-cubic-centimeters (g/cm³), moment of inertia in gram-square-centimeters (kg-m²) and the like.

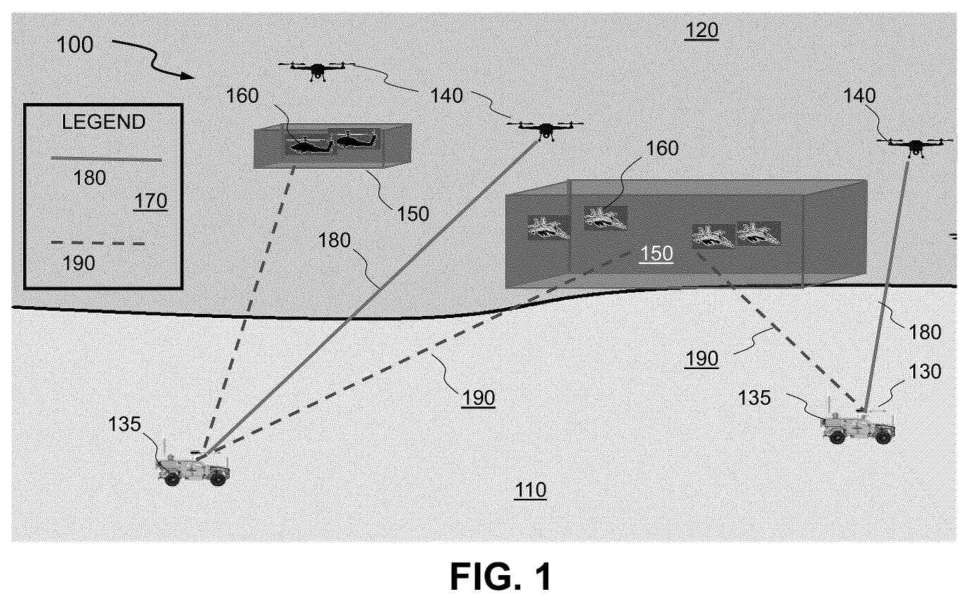

Exemplary embodiments provide a technique to define a plane for inhibiting a laser beam from passing through along a select direction. To begin, environmental conditions are described. FIG. 1 shows a block diagram view 100 of a targeting environment, including surface 110 and air 120. Laser weapons 130 are carried aboard transports 135 on the surface 110 with which to engage aerial targets 140 in the air 120, which also includes no-fire zones 150 containing assets 160. A legend 170 identifies directed electromagnetic energy beams 180 from the lasers 130 and fire-inhibit vectors 190 that mark edge boundaries for the no-fire zones 150.

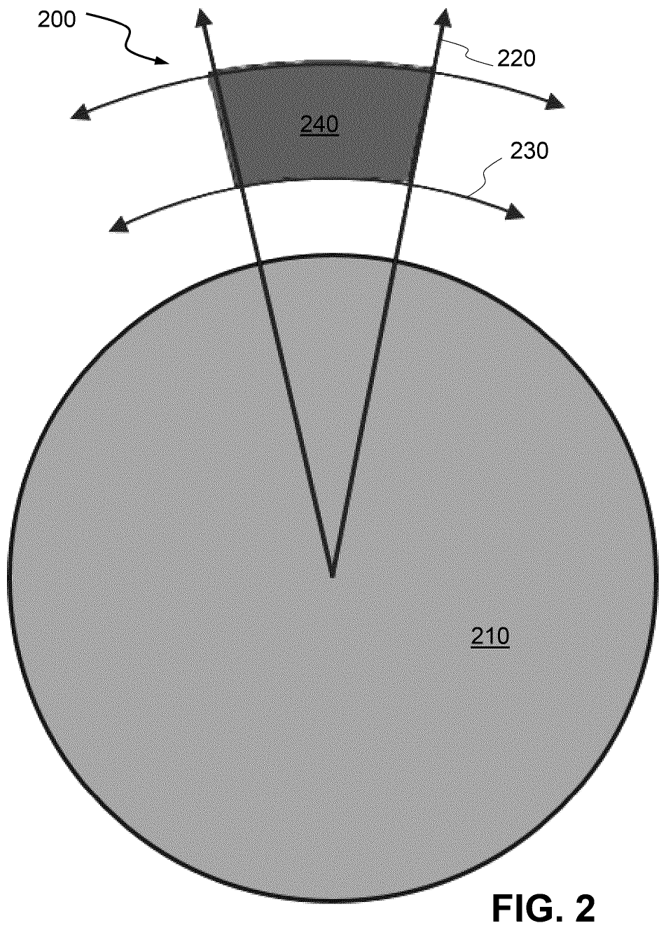

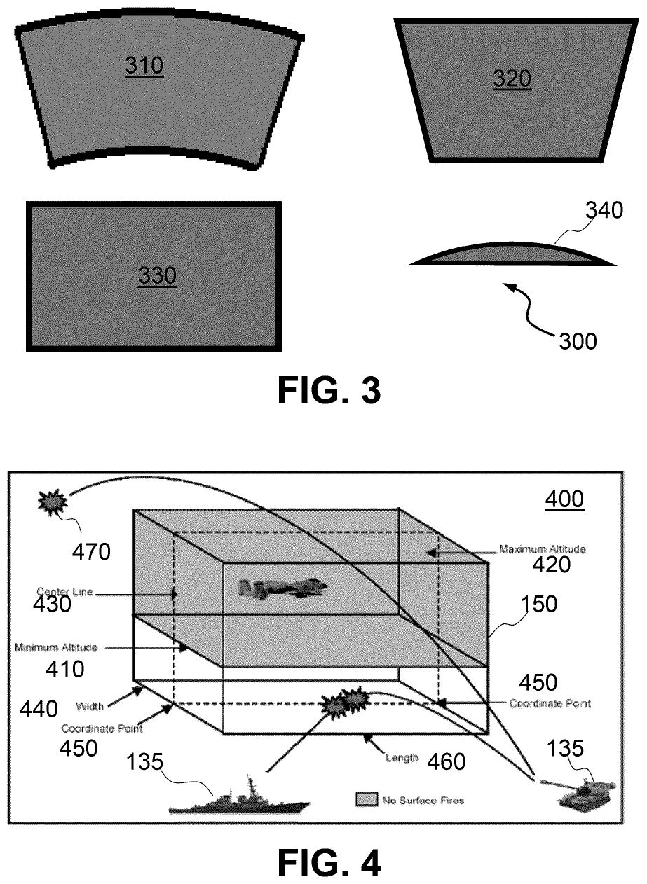

FIG. 2 shows a two-dimensional (2D) geometric representational view 200 of boundary definition of a zone 150. Earth 210 projects from its center radial vectors 220 and angular projections 230 that define a bounded region 240. FIG. 3 shows a two-dimensional representational view 300 of zone shapes. Radial and angular shape 310 analogous to bounded region 240 exhibits curvature at top and bottom and slopes along its sides. A quadrilateral shape 320 has parallel top and bottom and sloped sides. A rectangle 330 denotes parallel sides and right angles. A truncated arc 340 denotes a curved top and flat bottom. Alternative custom shapes can also be defined for boundary purposes.

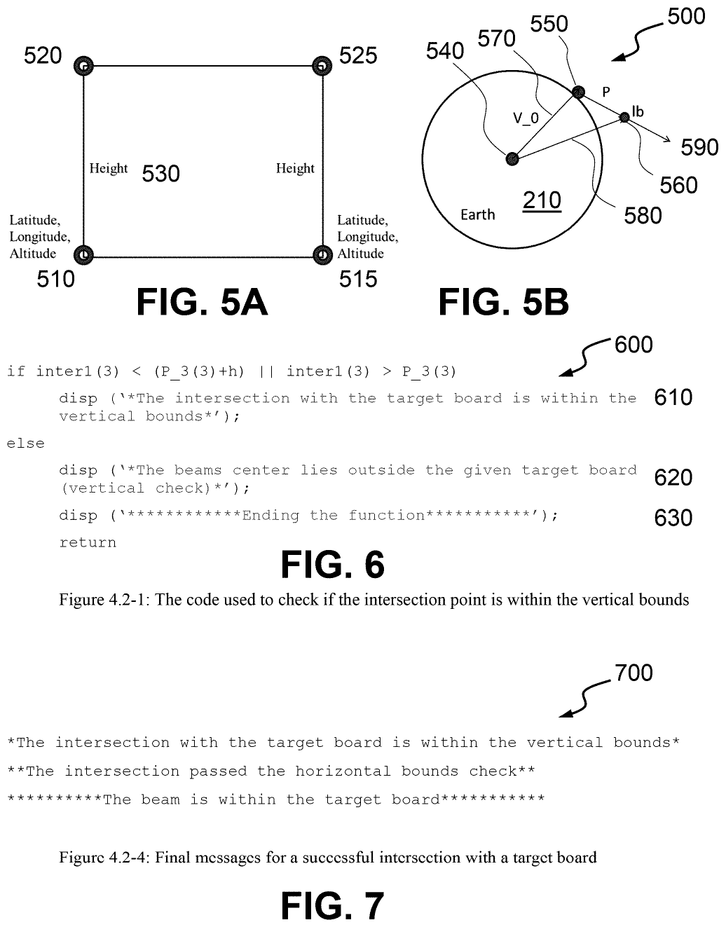

FIG. 4 shows a block diagram view 400 of environment boundaries in relation to the no-fire zone 150. The boundaries include minimum altitude 410 and maximum altitude 420, with a lateral centerline 430 passing midway across the width arc 440. The centerline 430 passes through coordinate points 450 straddled by the width 440 and length 460. Fire engagements 470 launched from platforms 130 operate external to the zone 150.

FIGS. 5A and 5B show two-dimensional geometric representational view 200 of associated boundaries and vectors. A zone 150 can be bounded by latitude, longitude and altitude (LLA) coordinates, including lower values 510 and 515 as well as higher values 520 and 525. The difference in these altitude values can be expressed as heigh h 530. Earth 210 has a center 540 from which radiates vectors 220 that intersect the spherical surface at an origin point 550 for the laser 130 and at altitude 560. First and second radial vectors 570 and 580 extend from the center 540 to respectively the origin point 550 and the altitude point 560. A directional vector 590 passes through points 550 and 560 for aiming the beam 180.

FIG. 6 shows a code line instruction view 600 of display for intersections 620 and external lines 630, along with routine exit 630. FIG. 7 shows a code text view 700 of target board intersection message.

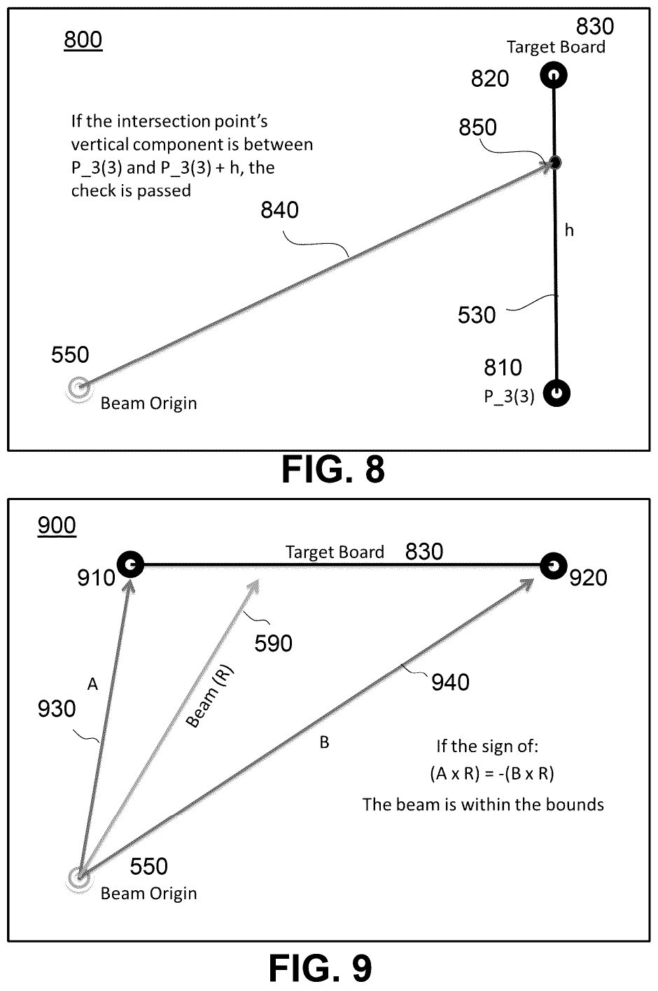

FIG. 8 shows a two-dimensional representational view 800 of vertical intersection along the radial vectors 220. Lower altitude bound 810 and upper altitude bound 820 form a target board 830 of height h 530. A vector 840 from the local origin 550 of the laser 130 intersects the target board 830 along the vertical height 530 at intersection 850. In the laser target board 830, latitude and longitude are defined in degrees, while altitude and the height of the target board 830 are in meters.

FIG. 9 shows a two-dimensional representational view 900 of horizontal intersection along the angular projections 230. Altitude points 910 and 920 demarcate the target board 830 along a horizontal boundary. Vector A 930 points between the origin 550 of the laser 130 and the first point 910, while vector B 940 points between the laser 130 and the second point 920. The beam 180 from the laser 130 as vector R intersects the target board 830 between points 910 and 920. When the sign of A×R=(B×R), then the beam 180 is within proper bounds and outside the no-fire zone 150.

Exemplary embodiments represent the result of an effort to establish a rapid way to define and construct a vertical planar target board 830 while determining whether a laser beam 180 passes through that target board 830 in the specified direction. The target board 830 is defined to be perpendicular to the local level with fixed altitude bottom and top edges. The direction of intersection 850 is defined as the beam 180 originating on one side of the target board 830, both sides of the target board 830, or no intersection permitted. This disclosure proposes a mathematical algorithm in conjunction with targeting hardware to solve this problem.

Requirements for laser weapon systems 130 may contain requirements for geodetic firing zones that are defined as geometric planes that are fixed relative to earth 210, which the laser energy must either pass through or must not pass through. These planes are necessary when implementing a laser system for many reasons. Testing a laser system 130 may need to be directed toward an area where lazing has been authorized. During the same test, there might be no-fire regions 150 where the laser 130 may not aim. During tactical operations, there may be regions where laser energy is permitted and other regions where laser energy is prohibited due to protected operations. The mathematical algorithm described in this disclosure defines these areas as two-dimensional vertical rectangular planes 530 that are fixed relative to earth 210.

The ultimate goal of these user defined regions in combination with this algorithm is to provide the ability for a laser weapon control system to generate an inhibit or permit message that can be sent to the laser system 130. This inhibit or permit determination is based on the inputs provided for the point of origin of the beam 180, the pointing angle of the beam 180 in local azimuth and elevation coordinates, and the geodetic position and height of the vertical plane 530. The algorithm provides not only a result that supports whether the laser system's firing ability should be inhibited or permitted, but also the coordinate point of where the beam 180 intersects the defined target board 830 if its vector 590 intersects the plane 530.

This algorithm provides the laser weapon control further capabilities beyond establishing one vertically oriented user defined region 240. This algorithm enables this multi-sided region 240 to be constructed, where the laser 130 will only be authorized to fire whether or not particular sides of the multi-sided region regions are intersected. This is accomplished by repeated application of the basic planar algorithm to a series of user defined regions.

The vertical plane, which is defined by the inputs to the algorithm, is fixed relative to earth 210. The area is defined as a planar target board 830 or a user defined region. This algorithm places constraints on the laser beam 180 such that it must pass through the planar region in a specified direction or not at all. User defined regions 240 are determined by the four points 510, 515, 520 and 525 that bound the rectangle 330 and the set of crossing direction(s). Each of these four corner points is defined by a latitude, a longitude, and an altitude (LLA). Considering that this target board 830 is vertical relative to the earth 210, each upper coordinate point shares the same latitude and longitude as its corresponding bottom coordinate.

A further, simplifying limitation is to have to top 410 and the bottom 420 edges of the region to each be at a fixed altitude above the earth 210. Crossing direction(s) are defined by the side of the plane that the beam 180 must enter. A given user defined region 240 will have as the crossing direction; one of the sides, both of the sides, or neither of the sides. Refer to views 400 and 500 for physical representations of this definition.

Directionality of crossing is determined by the angle between the normal to the plane and the direction of the beam 180. The normal to the plane is determined using the right- and rule and the order in which the points are specified. For the plane shown in view 500, if the left-hand point were specified first then the normal would be a vector into the viewplane. The normal can also be conceived as the normal to the plane defined by the great circle segment 230 from the left-hand point to the right-hand point.

The true representation of this region 150 is not a rectangle 330 by definition. The top 420 and bottom 410 of the target board 830 are technically segments of great circles 230, meaning they cannot be linear. The left and right sides of the target board 830 are segments of radials 220 extending from the center 540 of the earth 210 through the given coordinate points 510, 515, 520 and 525. By definition, radials are not parallel, meaning that the sides of the target board 830 are not parallel. This renders the actual shape of the region a section of an annulus. The exemplary algorithm solves the intersection problem of a laser beam 180 with this annulus.

Most actual user defined regions will be true rectangles 330 in the geometric sense with opposite sides parallel and having 90° interior angle. To see how far they deviate from the annular approximation used in the algorithm, two examples will be analyzed. For these analyses, a spherical earth 210 with a radius of 3441 nautical miles are used. The first example is the common usage of a target board 830, which represents a simple user defined region. This target board 830 is a thousand feet horizontally and five-hundred feet vertically. The second example is an extremely large target board 830 that is ten nautical miles horizontally and one nautical mile vertically.

The left and right vertical bounding edges, in this case, are parallel to within 0.0027°. The top and bottom bounding edges are the same length to within a range of 0.024 feet. To test the limits of this approximation, a much larger target board 830 was tested for comparison to a true rectangle 330. This larger target board 830 was defined laterally by ten nautical miles and vertically by one nautical mile.

The left and right vertical bounding edges, in this case, are parallel to within 0.166°. The top and bottom horizontal bounding edges were the same length to within 17.65 feet. Both of these common and extreme cases of the target board 830 show that that the rectangular approximation is sufficient to use when calculating an intersection 850 within them. User defined regions, when used in respect to laser systems, are quite generous in their surrounding borders. This means that with the approximation being off by 0.0027° and 0.024 feet in most cases, the difference it will make can be considered negligible. Thus, the target board 830 that represents the user defined region 220 is rectangular 330 for all intents and purposes.

The other inputs to the algorithm that need to be defined are the laser 130 for the beam origin 550 from the laser 130 and pointing direction 590 of the beam 180. The origin 550 will be defined by latitude, longitude, and altitude. The pointing direction 590 is defined by elevation and azimuth angles. The elevation angle denotes the arc between the beam direction 590 and horizontal. Azimuth is defined as the clockwise arc between the beam direction and North.

Process: (a) Calculate a first radial vector 570 normal to the planar region, such as earth's periphery. (b) Convert the beam origin 550 based on WGS-84 latitude-longitude-altitude (LLA) to earth-centered earth-fixed (ECEF). (c) Convert beam pointing direction 590 to ECEF based on azimuth, elevation for the beam origin 550. (d) Find point 850 where infinite beam 180 intersects infinite plane as height 530, which corresponds to a second radial vector 580. (e) Determine whether intersection 850 lies “in front” (i.e., in the path) of the beam origin 550 along the target board 830. (f) Determine whether intersection 850 is inside the bound of the planar region of the target board 830, meaning being within an excluded altitude plane. (g) Determine whether intersection 850 has the correct direction in relation to earth 210, meaning being within an excluded radial plane. A response can be displayed to an operator indicating whether vertical inhibition from step (f) and/or horizontal inhibition from step (g), or whether a default permits firing of the laser 130.

The first step is to calculate a vector that is normal to the planar region. This is accomplished by taking the vector cross product of the two radial vectors 570 and 580 that define the left and right edges of the region 150. The order of the cross product has no consequence as that product only affects the direction of the normal, which for the exemplary algorithm, does not matter.

The second step in the algorithm is to convert the laser origin 550 of the beam 180, which is given as latitude, longitude, and altitude coordinates into Earth Centered Earth Fixed coordinates. MATLAB includes a function called 11a2ecef that performs this operation.

The next step converts the beam's pointing direction 590, provided as azimuthal and elevation angles, to a unit vector in Earth Centered Earth Fixed coordinates. The beam's origin 550 at the laser 130 in latitude, longitude, and altitude is also needed in order to perform this calculation. MATLAB code is available for a function called aer2ecefn that performs this operation. The range used in this function is arbitrary. A range of one is used to create a unit vector.

If the pointing direction 590 of the beam 180 is perpendicular to the plane's normal vector for height 530, the beam 180 is parallel to the plane and therefore, does not intersect the plane. On the other hand, if the beam 180 is not parallel to the plane, there will be a point of intersection 850 of the beam 180, treated as an infinite line in both directions and the planar region, also treated as infinite in extent. The determination of perpendicularity is a simple verification of the dot product between the beam direction 590 and the normal to the plane with a dot product of zero indicating perpendicularity.

The entire mathematical algorithm shown in this document needs to convert the provided LLA inputs to the appropriate Cartesian coordinate system. Converting to this system facilitates simple computations to be conducted, enabling the user to solve for many things that are necessary for the laser system. The first conversion used in the algorithm is converting LLA coordinates to an earth-centered, earth-fixed (ECEF) Cartesian coordinate system. This ECEF coordinate system assumes the WGS84 ellipsoid model for earth considering earth is not a perfect sphere. A part of the algorithm is a function dedicated to carrying out this conversion.

The main algorithm that determines whether or not the beam 180 passes through the authorized or unauthorized region also returns the intersection 850 whether the beam 180 actually intersects the target board 830. This intersection 850 is calculated in Cartesian space. For convenience, this coordinate point is converted back from ECEF WGS84 Ellipsoid Cartesian coordinates to LLA.

The main function used to execute the intersection calculation is entitled “FinalBeamCheck.m” to distinguish authorized and unauthorized regions. This function goes through a series of steps that convert coordinates points 450, compute an intersection 850 with the relative infinite plane as height 530, check if the intersection 850 is within the bounded plane defined by the target board 830, check the directionality of the beam 180 in respect to the target board 830, and return the intersection 850 in the event it actually does exist.

The first part of the “FinalBeamCheck.m” function converts all of the latitude and longitude points provided in degrees to radians. The other conversion completed involves the conversion of the points that define the bounded target board 830 from latitude, latitude, and altitude to an ECEF coordinate system.

Upon converting all of the points so that the system is in a Cartesian space, the next step in the function calculates the normal to the established infinite plane as height 530. The objective for the infinite plane is to find the intersection 850 as early in the process as possible. Once this point 850 is identified, the intersection 850 can be checked with several techniques to determine whether lying within the bounded plane as defined by the specified target board 830. This is accomplished by taking the cross product of two specific vectors as vector 840.

The two vectors 930 and 940 in this process are established by taking the difference between the first lower bound point (P_1) and the first upper bound point (P_3), both in ECEF coordinates. The other difference taken for this cross product is between the first lower bound point (P_1) and the second lower bound point (P_2), both in ECEF coordinates. After the normal to the infinite plane as height 530 is calculated, this cross product is then normalized.

The next section within the algorithm is the general infinite plane intersection calculation. What is necessary to calculate the intersection 850 with the infinite plane is two individual points 550 and 560 on the beam 180. The first one is supplied by the source of the beam 180. The second one needs to be calculated. To do this, two vectors need to be added together to obtain the secondary point 560. The first vector 570 extends from the center 540 of the earth 210 to the beam source 550 at the laser 130, and the second vector 590 represents the actual beam 180, defined by an azimuth and elevation angle. See view 500 for a visual representation.

View 500 presents a visual representation for calculating the second point 560 on the beam 180. Once the second point 560 on the beam 180 has been calculated, another function entitled “intercheck.m” is called to determine the intersection point 850 between the beam vector 590 and the infinite plane as height 530.

This intersection technique is modeled after the general parametric form for calculating the intersection of a line and a plane in three-dimensional space. This technique for calculating the intersection requires two distinct points 550 and 560 along the vector 590 representing the beam 180, as well as three non-co-linear points in the plane. The general concept of this intersection method is to set the points on the line equal to the points on the plane.

This relation can be reformatted in a matrix format that enables the intersection 850 to be calculated as follows

$$⌊ \begin{matrix}{x}_{a} - {x}_{1} \\ {y}_{a} - {y}_{1} \\ {z}_{a} - {z}_{1}\end{matrix} ⌋ = ⌊ \begin{matrix}{x}_{a} - {x}_{b} & {x}_{2} - {x}_{1} & {x}_{3} - {x}_{1} \\ {y}_{a} - {y}_{b} & {y}_{2} - {y}_{1} & {y}_{3} - {y}_{1} \\ {z}_{a} - {z}_{b} & {z}_{2} - {z}_{1} & {z}_{3} - {z}_{1}\end{matrix} ⌋ ⌊ \begin{matrix}t \\ u \\ v\end{matrix} ⌋ , \qquad ( 1 )$$

where X, Y and Z are Cartesian coordinates with subscripts a, b, 1, 2 and 3 denote first and second points (550, 560) and non-co-linear points in the plane, and variables t, u, and v represent values to be solved by inverting the 3×3 matrix and multiplying that with the matrix on the other side of the relation. The matrix form of eqn. (1) reveals:

$${l}_{a} + ( {l}_{b} - {l}_{a} ) t = {p}_{1} + ( {p}_{2} - {p}_{1} ) u + ( {p}_{3} - {p}_{1} ) v , \qquad ( 2 )$$

where lₐ equals coordinates (xₐ,yₐ,zₐ) for first point 550, l_{b} equals coordinate (x_{b},y_{b},z_{b}) for second point 560 and p denotes non-co-linear point positions.

This three variable column vector └t u v┘ represents the intersection point 850 the laser beam 180 crosses with the infinite plane. If the beam 180 is parallel to the infinite plane as height 530, then the vectors l_{b}−lₐ, p₂−p₁, and p₃−p₁ will be linearly dependent and the matrix in eqn. (3) with be singular. Note that even if the beam vector 180 is parallel to the infinite plane defined by the bounded target board 830, one can nonetheless intersect the target board 830.

Once the intersection 850 with the infinite plane has been calculated, the direction vector 590 can be run through a series of checks to determine whether the beam 180 is entering the target board 830 through the correct side, while falling within bounds of the defined planar target board 830.

The purpose of checking whether or not the beam 180 is entering through the correct side of the target board 830 is to ensure that a ship or other platform 135 cannot sail around to the back side of a target board 830 and be authorized to fire through the other side. The directionality check is an easy one, as it is completed with two simple dot products. The first dot product is calculated with the vector entitled the “intersection_vector”, which is the direction vector 590 from the source to the intersection point 850, and the vector defined by the points lₐ 550 and l_{b} 560.

As long as this value is less than zero, the check passes. The second dot product check preforms a dot product between the vector that defines the normal to the plane, and the vector 590 that represents the beam vector 180. As long as this value is less than zero, it passes the check. These validity checks simply confirm direction of the beam 180. The next checks ensure that the intersection point 850 previously calculated falls within both the vertical and horizontal bounds of the bounded planar target board 830.

The vertical bounds check is a simple verification as well. The objective of this check is to verify whether or not the intersection point 850 with the infinite plane as height 530 falls within the known vertical bounds defined by the bounding points on the target board 830. Because the bottom bounding points of the target board 830 are known, as well as the height 530 of the target board 830, one can verify whether the intersection 850 falls within those bounds. The code in view 600 shows the check whether the intersection point 850 is within the vertical bounds. View 700 presents confirmation representation of this vertical bounds check component of the intersection point 850.

The horizontal bounds check is the final verification in the algorithm that ensures that the intersection with the infinite plane is within the bounded target board 830. This check reduces the target board 830 as well as the beam 180 to a two-dimensional problem that can be solved easily. Vectors are created from the beam's origin point 550 to the two bottom bounding points on the target board 830. This could be done with the top bounding points on the target board 830 as well.

The cross product is then taken between these two vectors 570 and 580, as well and the direction vector 590 that defines the beam 180. If the sign of these two individual cross products equals, then the intersection point 850 cannot be within the horizontal bounds set by the target board 830. Thus, the signs of the two cross products have to be opposite. A visual representation of these cross products and the two-dimensional arrangement for horizontal bounds verification is shown in view 800.

Once the intersection 850 has been run through all of these verifications, the intersection 850 can be confirmed to confined with the infinite plane as height 530 is within the bounded target board 830 specified by the operator. If it reaches this point, then the intersection point 850 is then converted from ECEF coordinates back to its respective latitude, longitude, and altitude and given to the user. The message the operator should receive in the command window if all checks are passed is as seen in view 700.

In response to the operator receiving this message in the command window, then the beam 180 has intersected the defined target board 830. With these messages, the intersection 850 with the target board 830 will be printed in the command window as view 700 in latitude, longitude, and altitude, where the latitude and longitude are in degrees and the altitude in meters.

This algorithm can be used repeatedly or on a case by case basis. When used repeatedly, it can be used to build a multi-sided figure without a horizontal top or bottom. A practical use for this is when a laser system 130 is being tested on a range and is required to exit the range at a specific altitude, without hitting any of the surrounding environment. If the beam 180 does not intersect with any of the bounding vertical planes that had been previously defined, then it left the test area at the necessary altitude.

With the state of Deconfliction Safety Software (DSS) remains in its planning stages, this algorithm that has proven to be functional as well as accurate is a great fit for low level safety in the geodetics portion of the DSS software. This can be implemented on a case by case basis or utilized in more advanced code to be implemented many times over to build a larger and more complex unauthorized region system. To further build off of the current algorithm, the beam 180 could be coded to be represented by a circle instead of a singular point. The beam for a laser system is not a perfect point. It has a specific radius and can bleed radially outward.

Multiple radii 220 could be programmed into the algorithm to specify which parts of the beam 180 the operator is concerned about intersecting with the target board 830. Each circle, specified by the radius, would contain four cardinal points 510, 515, 520 and 525. Each of these cardinal points would be run through the algorithm as it is now. If each of the four points is calculated to fall within the defined target board 830, then the entire beam 180 must fall within those bounds as well. Each of the bleed radii can have its respective four points run through the algorithm to determine whether or not it violates the unauthorized or authorized region.

This algorithm has the potential to suffer from one possible problem. Considering that the target board 830 is defined by two latitudes and two longitudes, as well as a height, it inherently requires at least those two points. When a target board 830 is very small, such as a couple meters in dimension, it would be quite difficult to establish latitude and longitude points that differ enough for these bounds. The global positioning system (GPS) instrumentation presumably available for testing events would rarely be precise enough to provide points to define such a small target board 830. Fortunately, the main application of this algorithm will be to determine the intersection 850 of a laser system 130 with a rather large unauthorized region 150.

The exemplary algorithmic process is designed for integration into the current DSS software. The mathematical side of the algorithm is easily implemented in any language and can be useful for a large spectrum of testing events that involve laser systems. As long as the geodetic location of the laser system 130 and the location of the authorized or unauthorized region are known, the intersection of the two can be easily found using the function.

When implemented properly within the DSS software, the algorithm can provide a vital layer of security for the laser system 130, being able to send the laser system 130 the authorization message for whether or not it can or cannot fire safely in relation to hitting what it should or should not strike. The DSS framework is further described in co-pending application Ser. No. 18/626,808.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A software method for inhibiting an electromagnetic beam emitted by a laser in a pointing direction from passing into a no-fire zone by defining a plane in relation to earth's center, said method comprising:
calculating a first radial vector from the earth's center to a beam origin of the laser in azimuth and elevation absent inhibition as default;
determining an intersection point along an a second radial vector initiating from said beam origin;
ascertaining whether said intersection point lies within an excluded radial plane to indicate an inhibition in response; and
displaying one of said inhibition and default.

2. The method according to claim 1, wherein said calculating said radial vector further includes:
converting said beam origin from latitude-longitude-altitude (LLA) coordinates to earth-center earth-fixed coordinates (ECEF); and
converting the pointing direction from said beam origin to ECEF.

3. The method according to claim 1, wherein said ascertaining whether said intersection point relates to at least one of an excluded radial plane to indicate said inhibition corresponds vertical, and an excluded altitude plane to said inhibition corresponds to horizontal.
